(19) United States
(12) Patent Application Publication
(10) Pub. No.: US 2014/0091804 A1
(43) Pub. Date: Apr. 3, 2014

(54) METHOD AND DEVICE FOR DETECTING LEAKAGE BRIGHT SPOT

(71) Applicant: SHENZHEN CHINA STAR OPTOELECTRONICS TECHNOLOGY CO., LTD., Shenzhen, Guangdong (CN)

(72) Inventors: Hao Huang, Shenzhen (CN); Zhiming Li, Shenzhen (CN); Chang-hung Pan, Shenzhen (CN)

(73) Assignee: SHENZHEN CHINA STAR OPTOELECTRONICS TECHNOLOGY CO., LTD., Shenzhen, Guangdong (CN)

(21) Appl. No.: 13/813,937

(22) PCT Filed: Nov. 15, 2012
(86) PCT No.: PCT/CN2012/084633

§ 371 Date: Feb. 1, 2013

(30) Foreign Application Priority Data
Sep. 29, 2012 (CN) 201210379434.8

(51) Int. Cl. G09G 3/00

(52) U.S. Cl. CPC G09G 3/006
USPC 324/414

(57) ABSTRACT

A method for detecting a leakage bright spot includes: providing a driving circuit of data lines and a gate drive of a gate side and connecting a terminal area of the gate side by conductive adhesive; dividing the terminal area of the gate side into a first area and a second area, turning on switches of pixel electrodes, and transmitting a driving signal to the data side; and detecting the leakage bright spot by optionally driving conductive terminals on the first area or the second area of the gate side. The present disclosure further provides a device for detecting a leakage bright spot.

### BACKGROUND

1. Technical Field

The present disclosure relates to technologies of liquid crystal panels, and particularly, to a method and device for detecting a leakage bright spot.

2. Description of Related Art

Leakage bright spots on TFT-LCD panel refer to bright spots caused by leakages of the TFT switches. Referring to FIG. 1, which is a schematic view of an abnormal TFT switch. As shown in FIG. 1, when the TFT switch is abnormal, a bright spot may appear on the liquid crystal panel, which affects the performance of the liquid crystal panel.

Given the detection cost into consideration, the lighting detection of the liquid crystal panel crystal panel in the Cell stage is carried out in the lDlG way. In the lighting detection of the liquid crystal panel, a driving circuit of data lines is provided to cooperate with conductive terminals of a gate side which are electrically connected by conductive adhesive to detect the leakage bright spot. However, the lDlG lighting detection way only brightens monochromatic black, white, and gray images. Specifically, to a VA type of liquid crystal panel, when one frame is black, the conductive terminals are conducted, the detecting frame does not input signals to the data lines, the pixel corresponding to the damaged TFT is displayed in black. When one frame is white, since white is formed by mixing three primary colors and the liquid crystals are required to be twisted to transmit light under electrical field force, at this time, the conductive terminals are conducted and the detecting frame inputs detecting signals to the data lines. Generally, the detecting signals input to the data lines can work directly on pixel electrodes and storage capacitors to allow the pixel corresponding to the damaged TFT to be displayed in white. Gray is midway between black and white. Similar to what mentioned above about white, the pixel corresponding to the damaged TFT is displayed in gray. It is concluded that the leakage bright spots caused by damaged TFTs cannot be detected in the Cell stage of the liquid crystal panel.

### SUMMARY

The present disclosure provides a method and a device for detecting a leakage bright spot on a liquid crystal panel in the Cell stage of the liquid crystal panel.

The method for detecting a leakage bright spot includes:

providing a driving circuit of data lines and a gate drive of a gate side and connecting a terminal area of the gate side by conductive adhesive;

dividing the terminal area of the gate side into a first area and a second area, turning on switches of pixel electrodes, and transmitting a driving signal to a data side; and

detecting the leakage bright spot by optionally driving conductive terminals on the first area or the second area of the gate side.

Preferably, the step of detecting the leakage bright spot by optionally driving conductive terminals on the first area of the gate side includes:

detecting the leakage bright spot on the second area by driving conductive terminals on the first area of the gate side rather than the conductive terminals on the second area of the gate side.

Preferably, the step of detecting the leakage bright spot by optionally driving conductive terminals on the second area of the gate side includes:

detecting the leakage bright spot on the first area by driving conductive terminals on the second area of the gate side rather than the conductive terminals on the first area of the gate side.

Preferably, the step of detecting the leakage bright spot on the second area includes:

driving the conductive terminals on the first area of the gate side rather than the conductive terminals on the second area of the gate side, after that, if there is any bright spot on the second area, the bright spot is the leakage bright spot.

Preferably, the step of detecting the leakage bright spot on the first area includes:

driving the conductive terminals on the second area of the gate side rather than the conductive terminals on the first area of the gate side, after that, if there is any bright spot on the first area, the bright spot is the leakage bright spot.

The device for detecting a leakage bright spot includes:

a switching signal generator for providing a driving circuit of data lines and a gate drive of a gate side, electrically connecting a terminal area of the gate side, dividing the terminal area of the gate side into a first area and a second area, turning on switches of pixel electrodes, and transmitting a driving signal to a data side; and

a switching signal transmitting unit for optionally driving conductive terminals on the first area or the second area to detect the leakage bright spot.

Preferably, that the switching signal transmitting unit drives conductive terminals on the first area to detect the leakage bright spot includes:

the switching signal transmitting unit drives conductive terminals on the first area rather than the conductive terminals on the second area to detect the leakage bright spot on the second area.

Preferably, that the switching signal transmitting unit drives conductive terminals on the second area to detect the leakage bright spot includes:

the switching signal transmitting unit drives conductive terminals on the second area rather than the conductive terminals on the first area to detect the leakage bright spot on the first area.

Preferably, that the switching signal transmitting unit detects the leakage bright spot on the second area includes:

after the switching signal transmitting unit drives the conductive terminals on the first area rather than the conductive terminals on the second area, if there is any bright spot on the second area, the bright spot is the leakage bright spot.

Preferably, that the switching signal transmitting unit detects the leakage bright spot on the first area includes:

after the switching signal transmitting unit drives the conductive terminals on the second area rather than the conductive terminals on the first area, if there is any bright spot on the first area, the bright spot is the leakage bright spot.

The present disclosure further provides another method for detecting a leakage bright spot, including:

providing a driving circuit of data lines, importing a gate drive of a gate side, and electrically connecting a terminal area of the gate side by conductive adhesive;

dividing the terminal area on the gate side into a first area and a second area according to the number of COF on the gate side, turning on switches of pixel electrodes, and transmitting a driving signal to a data side; and

detecting the leakage bright spot by optionally driving conductive terminals on the first area or the second area of the gate side.

Preferably, the step of detecting the leakage bright spot by optionally driving conductive terminals on the first area of the gate side includes:

detecting the leakage bright spot on the second area by driving conductive terminals on the first area of the gate side rather than the conductive terminals on the second area of the gate side.

Preferably, the step of detecting the leakage bright spot by optionally driving conductive terminals on the second area of the gate side includes:

detecting the leakage bright spot on the first area by driving conductive terminals on the second area of the gate side rather than the conductive terminals on the first area of the gate side.

Preferably, the step of detecting the leakage bright spot on the second area includes:

driving the conductive terminals on the first area of the gate side rather than the conductive terminals on the second area of the gate side, after that, if there is any bright spot on the second area, the bright spot is the leakage bright spot.

Preferably, the step of detecting the leakage bright spot on the first area includes:

driving the conductive terminals on the second area of the gate side rather than the conductive terminals on the first area of the gate side, after that, if there is any bright spot on the first area, the bright spot is the leakage bright spot.

Preferably, the step of dividing the terminal area on the gate side into a first area and a second area according to the number of COF on the gate side, turning on switches of pixel electrodes, and transmitting a driving signal to a data side comprises:

equally dividing the terminal area of the gate side into a first area and a second area if the number of the COF is even;

unequally dividing the terminal area of the gate side into a first area and a second area if the number of the COF is odd;

equally dividing the terminal area of the gate side into two areas arranged from top to bottom including a first area and a second area.

In the present disclosure, after providing the driving circuit of data lines, connecting the terminal area of the gate side via conductive adhesive, and dividing the terminal area into the first area and the second area, the switches of pixel electrodes are turned on, the driving signal is transmitted to the data side, and the conductive terminals on the two areas of the gate side are optionally driven to detect the leakage bright spot, which can detect the leakage bright spot in the Cell stage conveniently, improve the chance of detecting the defect of the liquid crystal panel, improve the yield rate of the products, and reduce leakage current.

### DESCRIPTION OF THE DRAWINGS

Many aspects of the embodiments can be better understood with reference to the following drawings. The components in the drawings are not necessarily dawns to scale, the emphasis instead being placed upon clearly illustrating the principles of the embodiments. Moreover, in the drawings, like reference numerals designate corresponding parts throughout the several views.

FIG. 1 is a schematic view of an abnormal TFT switch;

FIG. 2 is a flow chart of a method for detecting a leakage bright spot;

FIG. 3 is a schematic view illustrating the detection of a leakage bright spot of the liquid crystal panel;

FIG. 4 is a schematic view of a device for detecting a leakage bright spot in accordance with an embodiment of the present disclosure.

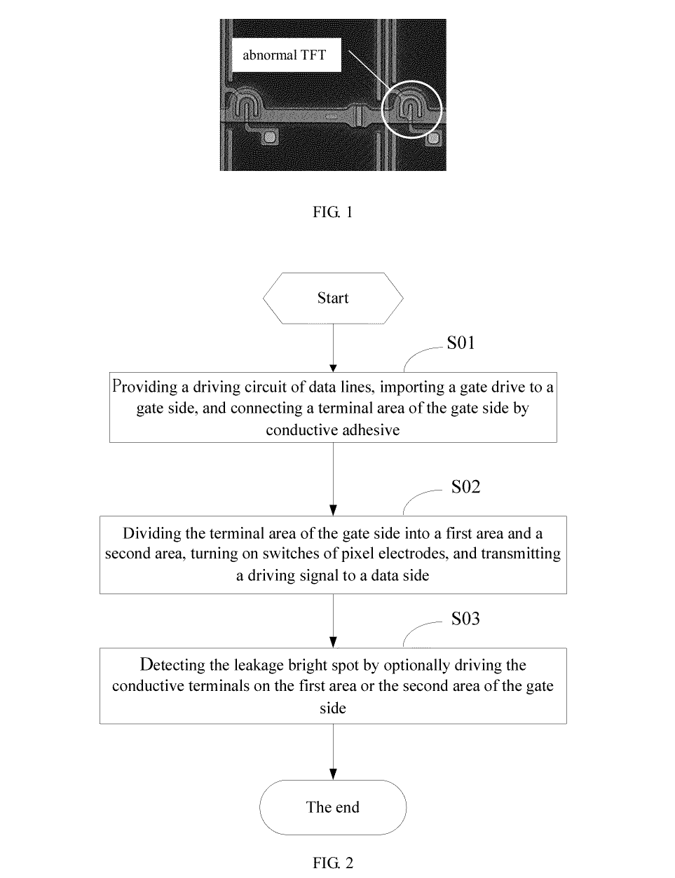

### DETAILED DESCRIPTION

The disclosure is illustrated by way of example and not by way of limitation in the figures of the accompanying drawings in which like references indicate similar elements. It should be noted that references to “an” or “one” embodiment is this disclosure are not necessarily to the same embodiment, and such references mean at least one.

Referring to FIG. 2, which is a flow chart of a method for detecting a leakage bright spot in accordance with an embodiment of the present disclosure. As shown in FIG. 2, the method includes the following steps:

Step S01, providing a driving circuit of data lines, importing a gate drive to a gate side, and connecting a terminal area of the gate side by conductive adhesive.

The detection of leakage bright spot on the liquid crystal panel is carried out in the cell stage of the liquid crystal panel. To a VA type of liquid crystal panel, the driving circuit of data lines is provided and the gate drive of the gate side is imported to cooperate with conductive terminals which are connected by the conductive adhesive on the terminal area to detect the leakage bright spot. In the embodiment, a switching signal generator at first provides the driving circuit of the data lines and imports the gate drive of the gate side, and then electrically connects the terminal area of the gate side by conductive adhesive.

Step S02, dividing the terminal area of the gate side into a first area and a second area, turning on switches of pixel electrodes, and transmitting a driving signal to the data side.

In order to detect the leakage bright spot on the liquid crystal panel conveniently, the terminal area of the gate side is divided into two areas, and then the switches of the pixel electrodes are turned on and the driving signal is transmitted to the data side.

In a preferred embodiment, the terminal area of the gate side is divided according to the number of the COF (Chip on Film) on the gate side. Specifically, if the number of the COF on the gate side is even, the first area and the second area are equal to each other; if the number of the COF on the gate side is odd, the first area and the second area are not equal to each other; if there is only one COF on the gate side, the gate side is divided into two equal parts arranged from top to bottom.

Step S03, detecting the leakage bright spot by optionally driving the conductive terminals on the first area or the second area of the gate side.

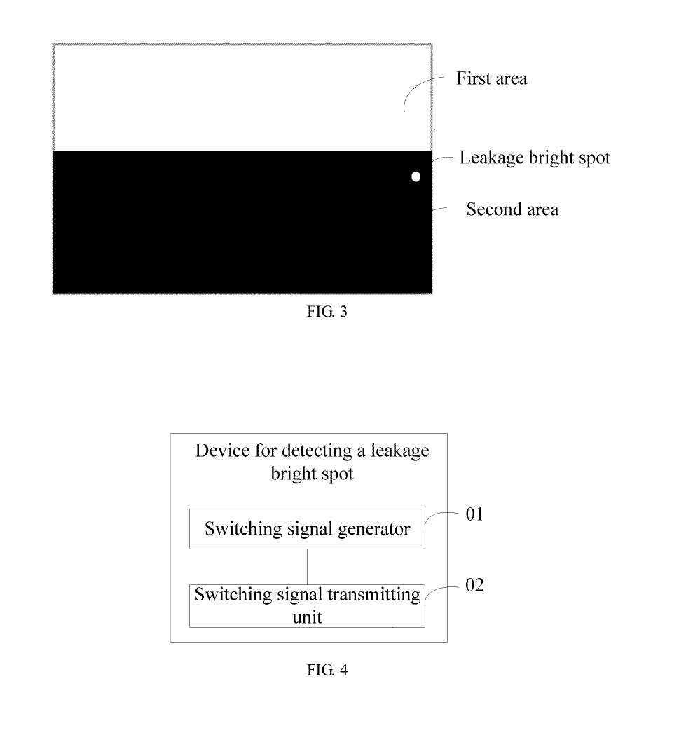

During the showing time of a frame, after the switches of the pixel electrodes are turned on, when the driving signal is being transmitted to the data side, driving the conductive terminals on the first area rather than the conductive terminals on the second area. At this state, to the first area, since the driving signal is transmitted to the data side and the conductive terminals on the first area are driven, thus, the liquid crystals corresponding to the first area are twisted to transmit light under electrical field force. At this time, the detecting frame inputs detecting signals to the data side and the gate side respectively. The detecting signals input to the data side work on the pixel electrodes and the storage capacitors directly, allowing the first area to be displayed in white. Since the conductive terminals on the second area are not driven, that is, no driving signal is input to the conductive terminals on the second area, thus, the second area is displayed in black if the liquid crystals in the second area are intact. If there is abnormality of TFT in the liquid crystals in the second area (such as leakage of TFT switch), the detecting signals input to the first area directly work on the pixel electrodes and storage capacitors of the liquid crystals. At this state, after the pixel electrodes of the liquid crystals in the second area are conducted, the position corresponding to the pixel electrode becomes bright to generate a leakage bright spot. Referring to FIG. 3, which is a schematic view of illustrating the detection of leakage bright spot on the liquid crystal panel. The detecting result shown in FIG. 3 shows that there is a leakage bright spot on the second area. As shown in FIG. 3, the leakage bright spot in the detecting area can be detected easily.

Similarly, the first area can be detected according to the same process, that is, in the showing time of a frame, after the switches of the pixel electrodes are turned on, driving the conductive terminals on the second area of the gate side rather than driving the conductive terminals on the first area of the gate side when transmitting the driving signal to the data side to detect the leakage bright spot on the first area.

In a preferred embodiment, a switching signal transmitting unit is configured for periodically displaying the black or white area to realize the detection of the leakage bright spot on the corresponding area of the liquid crystal panel.

In the present disclosure, after providing the driving circuit of data lines, importing the gate drive of the gate side, electrically connecting the terminal area of the gate side by conductive adhesive, and dividing the terminal area of the gate side into a first area and the second area, the switches of the pixel electrodes are turned on, the driving signal is transmitted to the data side, and the conductive terminals on the two areas of the gate side are optionally driven to detect the leakage bright spot. In this way, the leakage bright spot can be detected in the Cell stage of the liquid crystal panel to improve the chance of detecting the defect of the liquid crystal panel, to improve the yield rate of the products, and to reduce leakage current.

Referring to FIG. 4, which is a schematic view of a device for detecting a leakage bright spot. As shown in FIG. 4, the device includes a switching signal generator 01 for providing a driving circuit of data lines and importing a gate drive of a gate side.

The detection of the leakage bright spot on the liquid crystal panel is carried out in the Cell stage of the liquid crystal panel. To a VA type of liquid crystal panel, the switching signal generator 01 provides the driving circuit of data lines and imports the gate drive of the gate side, which cooperate with conductive terminals connected by conductive adhesive on the terminal area of the gate side to detect the leakage bright spot. In the embodiment, the switch signal generator 01 provides the driving circuit of data lines and imports the gate drive of the gate side.

In order to detect the leakage bright spot on the liquid crystal panel conveniently, the terminal area of the gate side is electrically connected by conductive adhesive and is divided into two areas: a first area and a second area. After that, the switches of the pixel electrodes are turned on and the driving signal is transmitted to the data side.

In a preferred embodiment, the terminal area of the gate side is divided according to the number of the COF (Chip on Film) on the gate side. Specifically, if the number of the COF on the gate side is even, the first area and the second area are equal to each other; if the number of the COF on the gate side is odd, the first area and the second area are not equal to each other; if there is only one COF on the gate side, the gate side is divided into two equal parts arranged from top to bottom.

The device for detecting a leakage bright spot further includes a switching signal transmitting unit 02 for optionally driving the conductive terminals on the first area or the second area of the gate side to detect the leakage bright spot.

During the showing time of one frame, after the switches of the pixel electrodes are turned on, when the driving signal is being transmitted to the data side, the switching signal transmitting unit 02 drives the conductive terminals on the first area rather than the conductive terminals on the second area. Thus, to the first area, since the driving signal is transmitted to the data side and the conductive terminals on the first area are driven, thus, the liquid crystals corresponding to the first area are twisted to transmit light under electrical field force. At this time, the detecting frame inputs detecting signals to the data side and the gate side respectively. The detecting signals of the data side work on the pixel electrodes and the storage capacitors directly, allowing the first area to be displayed in white. Since the switching signal transmitting unit does not drive the conductive terminals on the second area, that is, no driving signal is input to the conductive terminals on the second area. At this state, the second area is displayed in black if the liquid crystals in the second area are intact. If there is abnormality of TFT in the liquid crystals in the second area (such as leakage of TFT switch), the detecting signal input to the first area directly works on the pixel electrodes and storage capacitors, thus, after the pixel electrodes in the second area are conducted, the position corresponding to the pixel electrode becomes bright to generate a leakage bright spot. Referring to FIG. 3, which is a schematic view of illustrating the detection of leakage bright spot on the liquid crystal panel. The detecting result shown in FIG. 3 indicates that there is a leakage bright spot on the second area. As shown in FIG. 3, the leakage bright spot in the detecting area can be detected easily.

Similarly, the first area can be detected according to the same method, that is, in the showing time of a frame, after the switches of the pixel electrodes are turned on, driving the conductive terminals on the second area of the gate side rather than the conductive terminals on the first area of the gate side when transmitting the driving signal to the data side to detect the leakage bright spot on the first area.

In a preferred embodiment, the switching signal transmitting unit 02 can periodically display the black or white area to realize the detection of the leakage bright spot on the corresponding area of the liquid crystal panel.

In the present disclosure, after providing the driving circuit of data lines, importing the gate drive of the gate side, electrically connecting the terminal area of the gate side by conductive adhesive, and dividing the terminal area of the gate side into a first area and the second area, the switches of the pixel electrodes are turned on, the driving signal is transmitted to the data side, and the conductive terminals on the two areas of the gate side are optionally driven to detect the leakage bright spot. In this way, the leakage bright spot can be detected in the Cell stage of the liquid crystal panel to improve the chance of detecting the defect of the liquid crystal panel, to improve the yield rate of the products, and to reduce leakage current.

Even though information and the advantages of the present embodiments have been set forth in the foregoing description, together with details of the mechanisms and functions of the present embodiments, the disclosure is illustrative only; and that changes may be made in detail, especially in matters of shape, size, and arrangement of parts within the principles of the present embodiments to the full extend indicated by the broad general meaning of the terms in which the appended claims are expressed.

What is claimed is:

1. A method for detecting a leakage bright spot, comprising:
providing a driving circuit of data lines and a gate drive of a gate side and connecting a terminal area of the gate side by conductive adhesive;
dividing the terminal area of the gate side into a first area and a second area, turning on switches of pixel electrodes, and transmitting a driving signal to a data side; and
detecting the leakage bright spot by optionally driving conductive terminals on the first area or the second area of the gate side.

2. The method as claimed in claim 1, wherein the step of detecting the leakage bright spot by optionally driving conductive terminals on the first area of the gate side comprises:
detecting the leakage bright spot on the second area by driving conductive terminals on the first area of the gate side rather than the conductive terminals on the second area of the gate side.

3. The method as claimed in claim 1, wherein the step of detecting the leakage bright spot by optionally driving conductive terminals on the second area of the gate side comprises:
detecting the leakage bright spot on the first area by driving conductive terminals on the second area of the gate side rather than the conductive terminals on the first area of the gate side.

4. The method as claimed in claim 2, wherein the step of detecting the leakage bright spot on the second area comprises:
driving the conductive terminals on the first area of the gate side rather than the conductive terminals on the second area of the gate side, after that, if there is any bright spot on the second area, the bright spot is the leakage bright spot.

5. The method as claimed in claim 3, wherein the step of detecting the leakage bright spot on the first area comprises:
driving the conductive terminals on the second area of the gate side rather than the conductive terminals on the first area of the gate side, after that, if there is any bright spot on the first area, the bright spot is the leakage bright spot.

6. A device for detecting a leakage bright spot, comprising:
a switching signal generator for providing a driving circuit of data lines and a gate drive of a gate side, electrically connecting a terminal area of the gate side, dividing the terminal area of the gate side into a first area and a second area, turning on switches of pixel electrodes, and transmitting a driving signal to a data side; and
a switching signal transmitting unit for optionally driving conductive terminals on the first area or the second area to detect the leakage bright spot.

7. The device as claimed in claim 6, wherein that the switching signal transmitting unit drives conductive terminals on the first area to detect the leakage bright spot comprises:
the switching signal transmitting unit drives conductive terminals on the first area rather than the conductive terminals on the second area to detect the leakage bright spot on the second area.

8. The device as claimed in claim 6, wherein that the switching signal transmitting unit drives conductive terminals on the second area to detect the leakage bright spot comprises:
the switching signal transmitting unit drives conductive terminals on the second area rather than the conductive terminals on the first area to detect the leakage bright spot on the first area.

9. The device as claimed in claim 7, wherein that the switching signal transmitting unit detects the leakage bright spot on the second area comprises:
after the switching signal transmitting unit drives the conductive terminals on the first area rather than the conductive terminals on the second area, if there is any bright spot on the second area, the bright spot is the leakage bright spot.

10. The device as claimed in claim 8, wherein that the switching signal transmitting unit detects the leakage bright spot on the first area comprises:
after the switching signal transmitting unit drives the conductive terminals on the second area rather than the conductive terminals on the first area, if there is any bright spot on the first area, the bright spot is the leakage bright spot.

11. A method for detecting a leakage bright spot, comprising:
providing a driving circuit of data lines, importing a gate drive of a gate side, and electrically connecting a terminal area of the gate side by conductive adhesive;
dividing the terminal area on the gate side into a first area and a second area according to the number of COF on the gate side, turning on switches of pixel electrodes, and transmitting a driving signal to a data side; and
detecting the leakage bright spot by optionally driving conductive terminals on the first area or the second area of the gate side.

12. The method as claimed in claim 11, wherein the step of detecting the leakage bright spot by optionally driving conductive terminals on the first area of the gate side comprises:
detecting the leakage bright spot on the second area by driving conductive terminals on the first area of the gate side rather than the conductive terminals on the second area of the gate side.

13. The method as claimed in claim 11, wherein the step of detecting the leakage bright spot by optionally driving conductive terminals on the second area of the gate side comprises:
detecting the leakage bright spot on the first area by driving conductive terminals on the second area of the gate side rather than the conductive terminals on the first area of the gate side.

14. The method as claimed in claim 12, wherein the step of detecting the leakage bright spot on the second area comprises:
driving the conductive terminals on the first area of the gate side rather than the conductive terminals on the second area of the gate side, after that, if there is any bright spot on the second area, the bright spot is the leakage bright spot.

15. The method as claimed in claim 13, wherein the step of detecting the leakage bright spot on the first area comprises:
driving the conductive terminals on the second area of the gate side rather than the conductive terminals on the first area of the gate side, after that, if there is any bright spot on the first area, the bright spot is the leakage bright spot.

16. The method as claimed in claim 11, wherein the step of dividing the terminal area on the gate side into a first area and a second area according to the number of COF on the gate side, turning on switches of pixel electrodes, and transmitting a driving signal to a data side:
equally dividing the terminal area of the gate side into a first area and a second area if the number of the COF is even;
unequally dividing the terminal area of the gate side into a first area and a second area if the number of the COF is odd;
equally dividing the terminal area of the gate side into two areas arranged from top to bottom comprising a first area and a second area.
